(19) United States
(12) Patent Application Publication
(10) Pub. No.: US 2014/0223474 A1
(43) Pub. Date: Aug. 7, 2014

(54) INTERACTIVE MEDIA SYSTEMS

(71) Applicants: Tao Wang, Beijing (CN); Jianguo Li, Beijing (CN); Wenlong LI, Beijing (CN); Yimin Zhang, Beijing (CN); Qing Jian Edwin Song, Shanghai (CN); Yangzhou Du, Beijing (CN)

(72) Inventors: Tao Wang, Beijing (CN); Jianguo Li, Beijing (CN); Wenlong LI, Beijing (CN); Yimin Zhang, Beijing (CN); Qing Jian Edwin Song, Shanghai (CN); Yangzhou Du, Beijing (CN)

(21) Appl. No.: 13/994,815

(22) PCT Filed: Dec. 30, 2011
(86) PCT No.: PCT/CN2011/084970

§ 371 Date: Apr. 14, 2014

(51) Int. Cl. H04N 21/4415; H04N 21/4223

(52) U.S. Cl. CPC H04N 21/4415; H04N 21/4223; H04N 2101/00
USPC 725/34

(57) ABSTRACT

Generally this disclosure describes interactive media methods and systems. A method may include capturing an image, detecting at least one face in the image, determining an identity and expression corresponding to the at least one face, generating an icon for the at least one face based on the corresponding expression, and displaying the icon on a video monitor.

This disclosure relates to interactive media, and, more particularly, to indicators for interactive media, and the use thereof.

### BACKGROUND

Traditionally television was a medium where a channel/content was selected based on television listings or “surfing” through the channels. However, new services are emerging that are designed to enhance viewer experience, For example, printed television listings may now be replaced by Internet-driven applications. A visual summary of what is airing on each channel may be presented.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system in accordance with various embodiments of the present disclosure;

FIG. 2A. is a flowchart of example icon generation and display operations;

FIG. 2B. is a flowchart of example viewer identification operations;

FIG. 3 illustrates an example display image of an interactive media system according to one embodiment of the present disclosure;

FIG. 4 is a flowchart of example operations corresponding to the media system embodiment of FIG. 3;

FIG. 5 illustrates another example display image of an interactive media system according to another embodiment of the present disclosure; and

FIG. 6 is a flowchart of example operations corresponding to the media system embodiment of FIG. 5.

Although the following Detailed Description will proceed with reference being made to illustrative embodiments, many alternatives, modifications and variations thereof will be apparent to those skilled in the art.

### DETAILED DESCRIPTION

This disclosure is generally directed to interactive media systems and methods). In one embodiment, an interactive media system is provided that is configured to capture video images of viewers of a video monitor. The interactive media system is also configured to detect viewer faces in the images and to identify the viewers. Identifying the viewers may include comparing features of the faces detected in the images to a database of viewer profiles. The interactive media system may generate icons based on the detected faces and features and display the icons on the video monitor. In one embodiment the icons may be cartoons or sketches. In addition, the icons may be displayed on the video monitor along with one or more indicators. The indicators may identify, for example, the content currently being viewed by the viewer associated with the corresponding icon.

In one embodiment the content displayed on the video monitor is controlled by selecting an icon corresponding to a local viewer. After identifying the viewers and generating icons as described above, at least one icon is selected as the main viewer. The interactive media system determines the content preferences of the main viewer. For example, the interactive media system may access the database of viewers to determine the preferences. The interactive media system then selects content based on the preferences of the main viewer. Selecting the content may include comparing the preferences of the main viewer to a database of available content. The interactive media system may then display the selected content on the video monitor.

In one embodiment the content displayed on the video monitor is controlled by selecting an icon corresponding to a remote viewer. A local viewer may be associated with a plurality of remote viewers into a defined group. Each of the viewers in the group may be identified, and icons may be generated and displayed for each of the viewers. Moreover, the interactive media system may determine what each user in the group is watching, and may display icons for all of the other viewers in the group. Indicators may be displayed adjacent to each icon identifying the content being viewed by the viewer associated with the icon. The interactive media system may then allow the selection of an icon, causing content associated with the icon the be displayed on the video monitor.

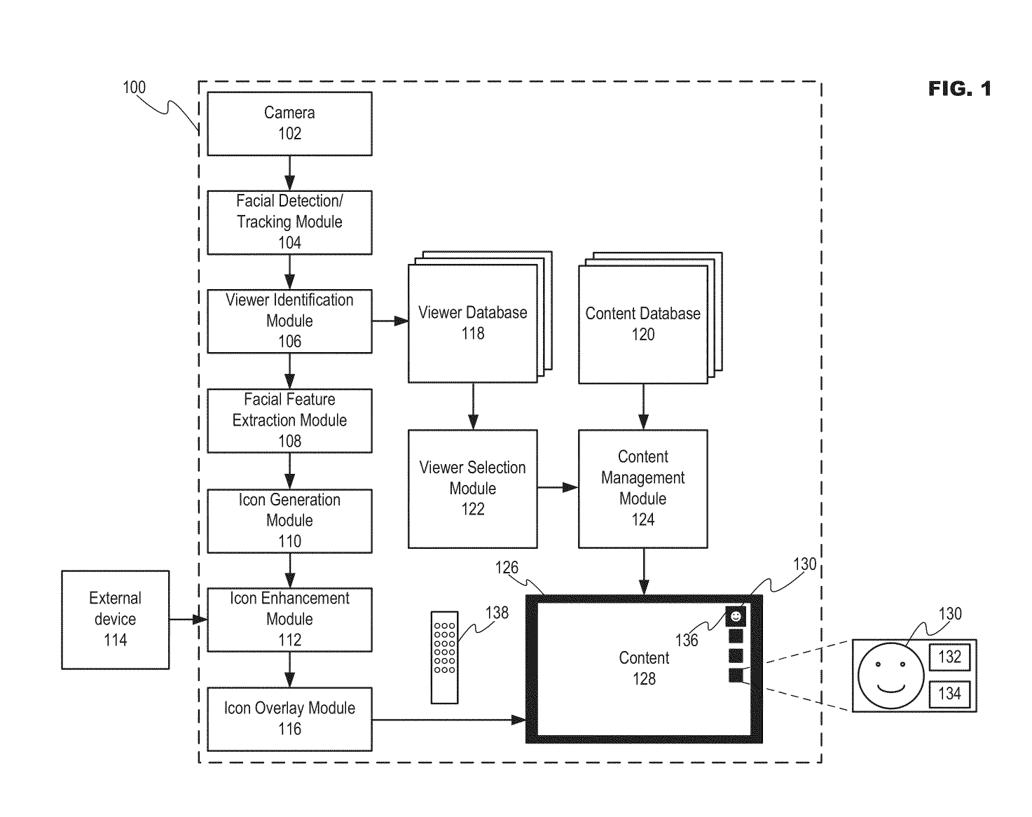

FIG. 1 illustrates a system 100 consistent with various embodiments of the present disclosure. System 100 is generally configured to detect/track viewers of a video monitor, to identify the viewers, to generate icons for each viewer, to display the icons onto a video monitor, and to display content on the video monitor. System 100 includes camera 102. Camera 102 may be any device for capturing digital images representative of an environment that includes one or more persons, and may have adequate resolution for face analysis of the one or more persons in the environment as described herein. For example, camera 102 may include a still camera (e.g., a camera configured to capture still photographs) or a video camera (e.g., a camera configured to capture a plurality of moving images in a plurality of frames). Camera 102 may be configured to operate with the light of the visible spectrum or with other portions of the electromagnetic spectrum not limited to, the infrared spectrum, ultraviolet spectrum, etc. Camera 102 may be incorporated within another component of system 100 (e.g., within TV 126) or may be a standalone component configured to communicate with at least facial detection module 104 via wired or wireless communication. Camera 102 may include, for example, a web camera (as may be associated with a personal computer and/or video monitor), handheld device camera (e.g., cell phone camera, smart phone camera (e.g., camera associated with the iPhone®, Android®-based phones, Blackberry®, Palm®-based phones, Symbian®-based phones, etc.)), laptop computer camera, tablet computer (e.g., but not limited to, iPad®, Galaxy Tab®, and the like), etc.

Facial detection/tracking module 104 is configured to identify a face and/or facial region within image(s) provided by camera 102. For example, facial detection/tracking module 104 may include custom, proprietary, known and/or after-developed face recognition code (or instruction sets), hardware, and/or firmware that are generally well-defined and operable to receive a standard format image (e.g., but not limited to, a RGB color image) and identify, at least to a certain extent, a face in the image. Facial detection/tracking module 104 may also be configured to track the detected face through a series of images (e.g., video frames at 24 frames per second). Known tracking systems that may be employed by facial detection/tracking module 104 may include particle filtering, mean shift, Kalman filtering, etc., each of which may utilize edge analysis, sum-of-square-difference analysis, feature point analysis, histogram analysis, skin tone analysis, etc. Viewer identification module 106 is configured to determine an identity associated with a face, and may include custom, proprietary, known and/or after-developed facial characteristics recognition code (or instruction sets) that are generally well-defined and operable to receive a standard format image (e.g., but not limited to a RGB color image) from camera 102 and to identify, at least to a certain extent, one or more facial characteristics in the image. Such known facial characteristics systems include, but are not limited to, the CSU Face Identification Evaluation System by Colorado State University.

Viewer identification module 106 may also include custom, proprietary, known and/or after-developed facial identification code (or instruction sets) that is generally well-defined and operable to match a facial pattern to a corresponding facial pattern stored in a database. For example, viewer identification module 106 may be configured to compare detected facial patterns to facial patterns previously stored in viewer database 118. Viewer database 118 may comprise accounts or records including content preferences for users. In addition, viewer database 118 may be accessible locally or remotely (e.g., via the Internet), and may be associated with an existing online interactive system (e.g., Facebook, MySpace, Google+, Linked In, Yahoo, etc.) or may be proprietary for use with the interactive media system. Viewer identification module 106 may compare the patterns utilizing a geometric analysis (which looks at distinguishing features) and/or a photometric analysis (which is a statistical approach that distills an image into values and comparing the values with templates to eliminate variances). Some face recognition techniques include, but are not limited to, Principal Component Analysis with eigenfaces (and derivatives thereof), Linear Discriminate Analysis with fisherface (and derivatives thereof), Elastic Bunch Graph Matching (and derivatives thereof), the Hidden Markov model (and derivatives thereof), and the neuronal motivated dynamic link matching.

Facial feature extraction module 108 is configured to recognize various features (e.g., expressions) in a face detected by facial detection/tracking module 104. In recognizing facial expression (e.g., identifying whether a previously detected face is happy, sad, smiling, frown, surprised, excited, etc.), facial feature extraction module 108 may further include custom, proprietary, known and/or after-developed facial expression detection and/or identification code (or instruction sets) that is generally well-defined and operable to extract and/or identify facial expressions of a face. For example, facial feature identification module 108 may determine size and/or position of the facial features (e.g., eyes, mouth, cheeks, teeth, etc.) and compare these facial features to a facial feature database which includes a plurality of sample facial features with corresponding facial feature classifications (e.g., smiling, frown, excited, sad, etc.).

Icon generation module 110 is configured to convert the facial image that was detected by facial detection module 104, and analyzed by facial feature extraction module 108, into an icon 130 for displaying on video monitor 126. For example, icon generation module 110 may further include custom, proprietary, known and/or after-developed image processing code (or instruction sets) that is generally well-defined and operable to convert real time images captured by camera 102 into other formats. In one embodiment, icon generation module 110 may convert facial images into cartoons or sketches for use as icons 130. As referenced herein, a cartoon may be defined as a fanciful image based on areal subject. For example, a cartoon may exaggerate one or more features of a real subject. Some cartoons may include, for example, limited-definition and/or limited-color palette rendering (e.g., four-color rendering, eight-color rendering, etc.) when compared to the real subject. As referenced herein, a sketch may be defined as a rough image that realistically resembles a real subject. For examples, sketches may include line drawing representations of the real subject in a single color (e.g., black on a white background). For example, facial images that were identified by facial detection module 104 may be clipped, and cartoon/sketch-like icons may be generated by image processing using line sketch extraction, distortion, example-based facial sketch generation with non-parametric sampling, grammatical model for face representation and sketching, etc. Alternatively, characteristics of the face identified by facial feature extraction module 108 (e.g., features and expression) may be applied to a preexisting cartoon icon model to create a representation of the face in cartoon form. An advantage of using a cartoon/sketch-like icon vs. a more realistic graphic image or 2D/3D avatar representation is that the cartoon/sketch is more robust and easier to generate/update than 2D/3D graphic model constructions. In addition, the true identity of the viewer corresponding to an icon may remain hidden, allowing viewers to operate anonymously in public forums and to interact with previously unknown viewers without being concerned that their actual identity will become known. Since a viewer's facial position and expression will change constantly while viewing video monitor 126, icon 130 may be dynamic to represent the viewer's most recent position and expression. In practice, icon 130 may be updated to represent the current expression of the viewer real time (e.g., frame by frame as provided by camera 102), at an interval, such as updating icon 130 every ten seconds, or never (e.g., icon 130 remains unchanged from when first created by icon generation module 110). The interval at which icon 130 is updated may depend various factors such as the abilities (e.g., speed) of camera 102, the graphic processing capacity available in system 100, etc.

Icon enhancement module 112 may be configured to alter the appearance of icon 130. For example, a viewer may deem that icon 130 created by icon generation module 110 is too lifelike or not lifelike enough. Alternatively, the viewer may desire for icon 130 to look whimsical or silly. In one embodiment, icon 130 may be altered manually by the viewer. For example, external device 114 may be a desktop PC, laptop PC, tablet computer, cellular handset, etc. External device 114 may access system 100 via local wired or wireless communication, via a web service hosted locally in system 100 (e.g., using the IP address of a server in system 100) or via a web service hosted elsewhere on the Internet. For example, a web service may provide access to icon 130 based on the viewer profile stored in viewer database 118. The web service may provide the viewer with an interface allowing the viewer to view and edit icon 130. The viewer may then alter various aspects of icon 130 (e.g., eyes, nose, mouth, hair, etc.) to make them thinner, thicker, more exaggerated, etc. in accordance with the viewer's preferences.

Icon overlay module 116 may be configured to display icon 130 over content 128 on video monitor 126. In one embodiment, icon 130 may be configured to overlay content 128 so that Viewers may observe both at once. Icons 130 may be arranged in various positions on the display of video monitor 126, and the position of icons 130 may be configurable so as not to obstruct viewing of content 128. Icons 130 for all Viewers currently watching content 128 on video monitor 126 may be displayed over content 128. In particular, icons 130 may be generated for all viewers physically present and watching video monitor 126. Icons 130 for other people of interest (e.g., friends, relations, business associates, etc.) that are watching their own TVs may also be displayed over content 128 on video monitor 126. This may alert viewers that are viewing content 128 on video monitor 126 that the other people of interest are also watching their own video monitors 126. In one embodiment, indicators 132 and 134 may also be displayed adjacent to icon 130. Indicators 132 and 134 may pertain to characteristics of TV operation. For example, indicator 132 may identify the channel being viewed by the Viewer corresponding to adjacent icon 130, and indicator 134 may identify the particular programming being viewed. As a result, a viewer that sees icon 130 along with indicators 132 and 134 may be informed as to the channel and programming that another viewer is currently watching.

Viewer selection module 122 may be configured to provide input to content management module 124 to control video monitor 126. Viewer selection module 122 may be configured to receive input (for example from remote control 138) to select an icon 130 that is displayed on video monitor 126. For example, a viewer may move selection box 136 to select a displayed icon 130. The selection of a particular icon 130 may cause viewer selection module 122 to receive viewer information from viewer database 122, the information including viewer characteristics and/or preferences. The information may be provided to content management module 124, which may be configured to select content from content database 120 based on the user profile. Content database 120 may comprise information on available content such as, but not limited to, current live broadcast schedules for network and cable television, on-demand programming including previously aired network and cable programming, movies, games, etc., content downloadable from the Internet, etc. Content database 120 may also include other characteristic information corresponding to the available content, like ratings indicating the age-appropriateness of the content, etc.

During operation of system 100, the viewer associated with icon 130 highlighted by selection box 136 may have a profile stored in viewer database 118 indicating that the viewer is a child (e.g., under a certain age). Viewer selection module 122 may then provide the age information to content management module 124. Content management module 124 may be configured to access content database 120 to select content 128 that is appropriate for the age of the viewer, and likewise, to restrict content 128 that is inappropriate for the viewer. It may also be possible for certain types of content 128 (e.g., cartoons, news, live sports, movies, etc.) or certain topics of content 128 (e.g., dinosaurs, technology, etc.) to be aired based on viewer preferences that are indicated in viewer database 118. Moving selection box 136 to the icon 130 corresponding to another viewer may change the viewer characteristics/preferences, and thus, alter content 128.

In one embodiment content management module 122 may also be configured to select content 128 based on a remote viewer in a viewer group. For example, a viewer viewing content 128 on video monitor 126 may see, aside from his/her own icon 130, icons 130 corresponding to a group other viewers of interest (e.g., friends, relations, business associates, etc.). The members of a viewer's group may be stored in the viewer's profile in viewer database 118. When a viewer is identified by viewer identification module 126, information on the viewer's group may be used to display icons 130 corresponding to all of the group members that are currently viewing their own video monitors 126 (e.g., in their own system 100). Indicators 132 and 134 may also be displayed over content 128 adjacent to each icon 130. Indicators 132 and 134 may inform the viewer of the channel and/or content that each group member is viewing. Upon viewing icons 130 along with indicators 132 and 134, the viewer may become interested in the content that is currently being viewed by one or more of the group members. In one embodiment, the viewer may “follow” what another viewer is watching by activating a follow function in system 100. The follow function may be activated by a code-based trigger (e.g., a menu, button, selection box, etc. displayed over content 128 that may be selected using remote control 128) or another type of trigger (e.g., a physical “follow” button on remote control 138). In one embodiment, the follow function may be configured to cause viewer selection module 122 to access viewer database 118 to obtain information about the content currently be viewed by the group member corresponding to the selected icon 130. This information may then be provided to content management module 124 to change content 128 to the content reflected by indicators 132 and 134 adjacent to the selected icon 130. Repeatedly triggering the follow function (e.g., repeatedly pressing the follow button on remote 138) may trigger different actions depending on the implementation of system 100. For example, repeatedly pressing the follow button may cause selection box 136 to move from one displayed icon 130 to the next, and likewise, to change content 128 according to the icon 130 that is currently selected. Alternatively, repeatedly pressing the follow button may cause content 128 to traverse through “favorite” channels or content for the group member whose icon 130 is currently selected. The favorite channels and/or programming may be available from the group member's profile in viewer database 118.

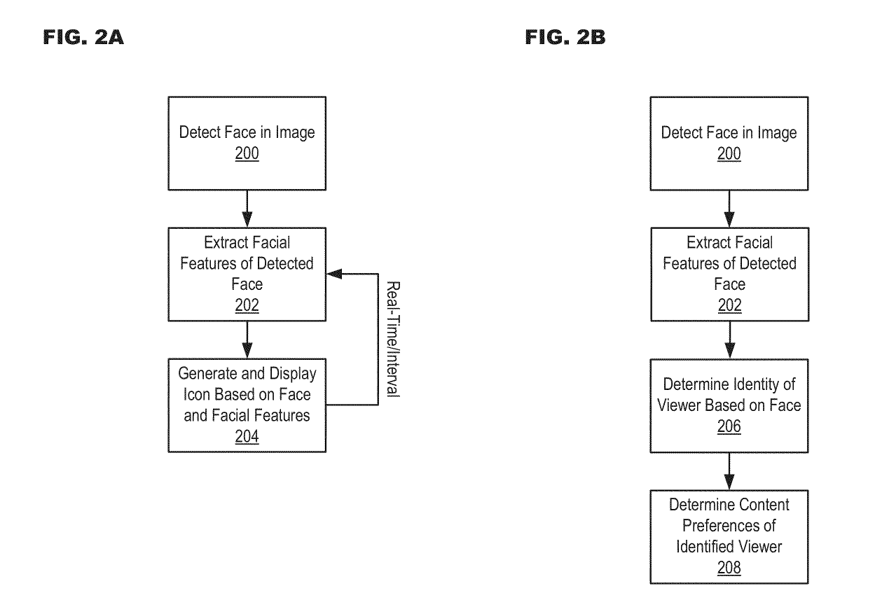

A flowchart of example operations for face detection and icon generation is illustrated in FIG. 2A. In operation 200 at least one face may be detected in an image. For example, camera 102 in system 100 may capture images of viewers that are currently viewing video monitor 126. Any faces detected in operation 00 may then be analyzed in operation 202 to extract features of the detected faces. For example, the extraction of facial features may comprise the detection of characteristics usable for determining the identity of the face and the expression on the face (e.g., happy, sad, angry, surprised, bored, etc.) In operation 204 an icon may be generated based on the facial features generated and then displayed on video monitor 126. For example, a cartoon or sketch icon having features resembling the detected face may be generated and then displayed. Operations 202 and 204 may continue to loop on an real-time or interval basis in order to update the appearance icon to resemble the current expression of the viewer.

A flowchart of example operations for face detection and viewer identification is illustrated in FIG. 2B. As in FIG. 2A, the initial operations 200 and 202 include detecting at least one face in an image captured by camera 102 and then extracting facial features. For example, camera 102 may capture images of viewers watching video monitor 126. The faces of viewers in the image may be detected, and then features usable for identifying the faces may be extracted. In operation 206 the identity of any viewers in the image may be determined based on the features that were extracted in operation 202. For example, the extracted facial features may be compared to a viewer database 118 containing viewer profiles. The viewer profiles may contain viewer characteristics (e.g., age, sex, preferences, interests, etc.) that may be utilized in operation 208 to determine the content preferences of the identified user. For example, the age of the viewer may indicate the content that would be appropriate/inappropriate for the viewer, and the preferences and/or interests may be used to select specific content from within the appropriate content.

Local Viewer Content Control

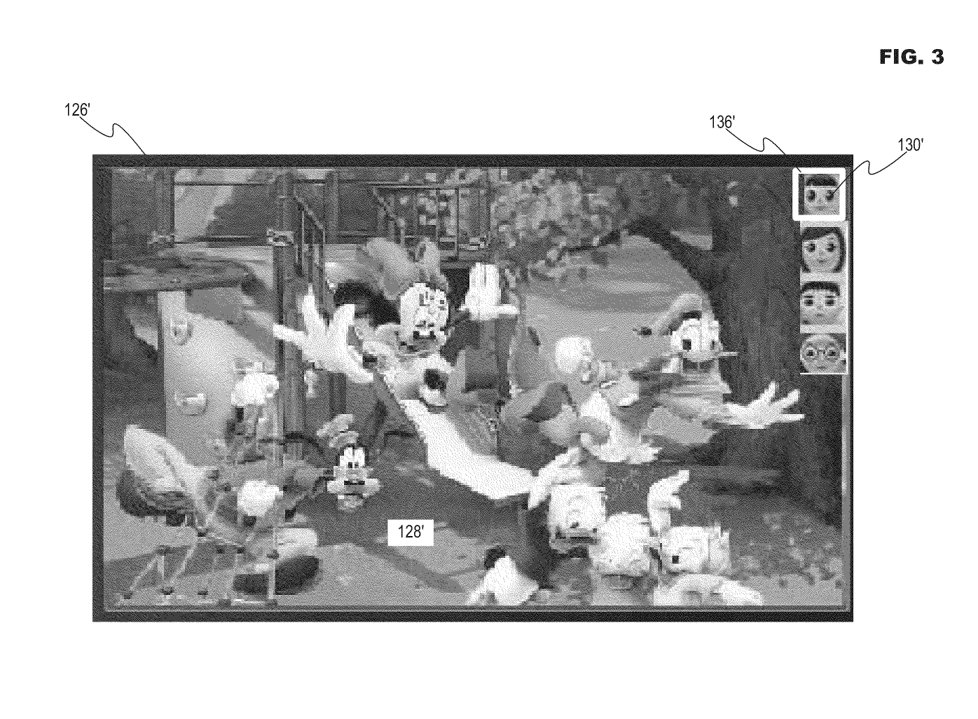

FIG. 3 illustrates an example implementation in accordance with a local viewer content control embodiment. In FIG. 3 video monitor 126′ is displaying content 128′, which is a cartoon program. Four icons 130′ are also displayed aver content 128′. Icons 130′ are cartoons that may represent the faces and expressions of viewers currently watching video monitor 126′. Selection box 136′ indicates that one of the icons 130′ is currently selected. Selected icon 130′ appears to have a face resembling that of a small child. As a result, content 128′ (e.g., TV programs and advertisements) may be selected based on what is appropriate for a viewer that is a small child including, of course, cartoon programs.

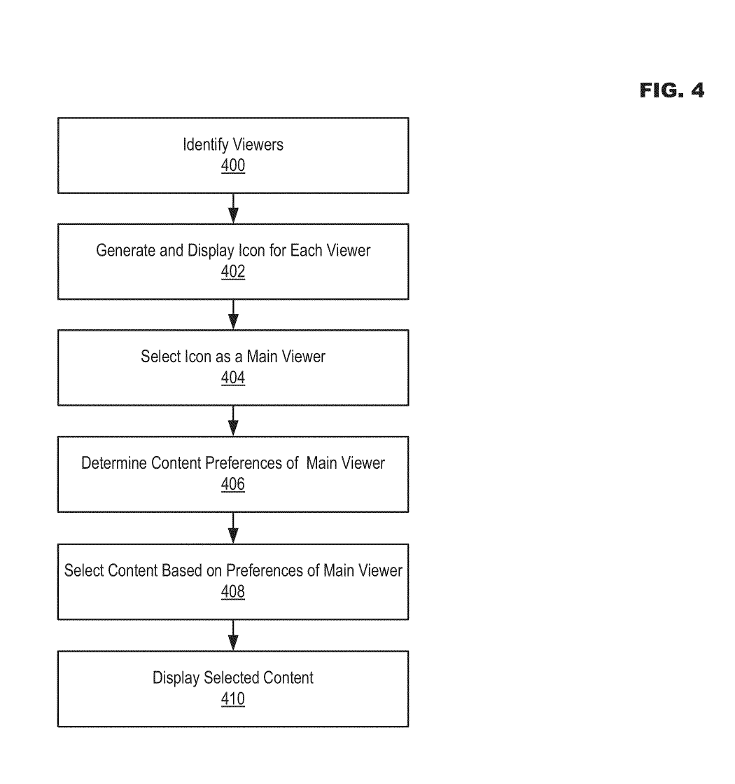

FIG. 4 illustrates example operations corresponding to the local viewer content control embodiment shown in FIG. 3. In operations 400 and 402 the faces of viewers present watching video monitor 126′ may be detected, the features of the detected faces may be detected, viewers associated with the detected features may be identified and icons may be displayed for each identified viewer as described, for example, in FIG. 2A and 2B. In operation 404 an icon may be selected as the main viewer of video monitor 126′. Selection of the viewer, may occur, for example, by moving selection box 136′ over one of the displayed icons 130′. In operation 406 the content preferences of the main viewer may be determined, for example, by accessing a viewer database containing a profile for the selected viewer. In operation 408 content may be selected for the main viewer depending on the viewer preferences. For example, information such as age, preferences and interests may be used to select appropriate content from a content database. In operation 410 the selected content may be displayed on video monitor 126′. In the instance of FIG. 3 the main viewer was a child, and so content 128′ is a children's program.

Group-Based Content Control

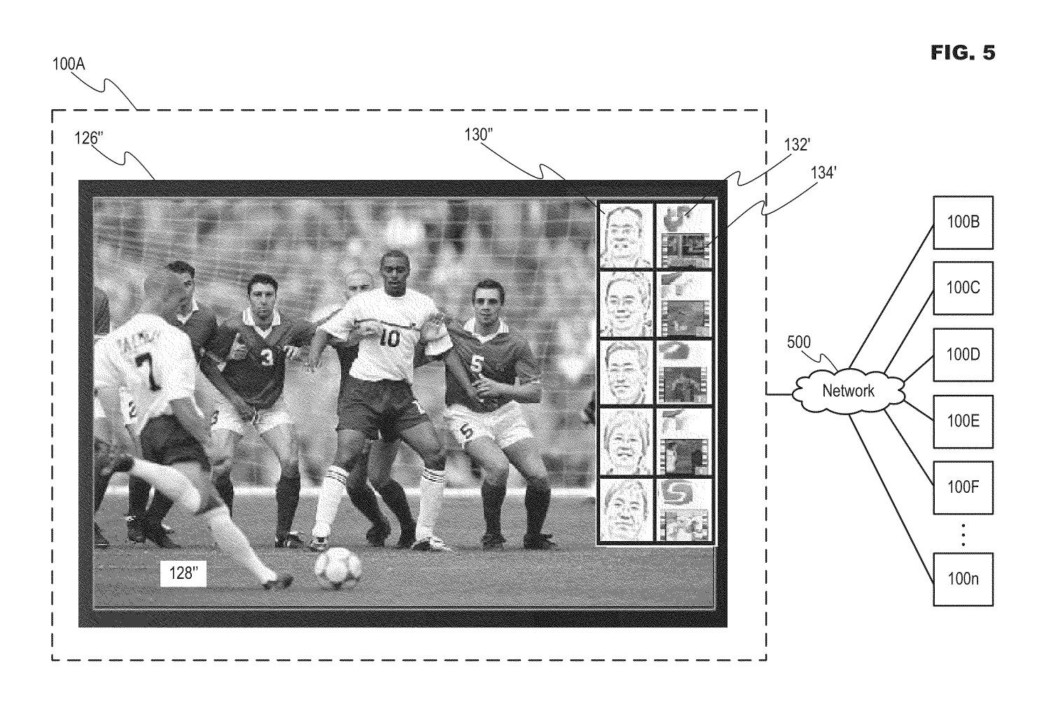

FIG. 5 discloses another example implementation in accordance with one embodiment. In FIG. 5 video monitor 126″ is part of system 100A that is coupled to other systems 100B to 100n via network 500 (e.g., the Internet). Video monitor 126″ is displaying content 128″, which is alive sporting event. Five icons 130″ are also displayed on video monitor 126″. Icons 130″ are sketches of viewers using systems 100A to 100n (e.g., based on images obtained by camera 102 in those systems). One of icons 130″ may correspond to a viewer watching video monitor 126″, while the other four icons may correspond to viewers in systems 100B to 100n that are members of a viewer group (e.g., friends, relations, business associates, etc). In the disclosed example indicators 132′ and 134′ are displayed adjacent to icons 130″. Indicators 132′ may be symbols corresponding to channels that are being viewed by viewers associated with each icon 130″. Indicators 134′ may be images or snapshots taken from content being watched by viewers associated with each icon 130″. Upon viewing icons 130″ along with indicators 120′ and 122′, a viewer may be aware of the other currently-active group members and the channels/programs that the other group members are viewing. If content being viewed by another group member appears interesting, a viewer may select to follow the other group member to view the identified content or other content recommended by the other viewer.

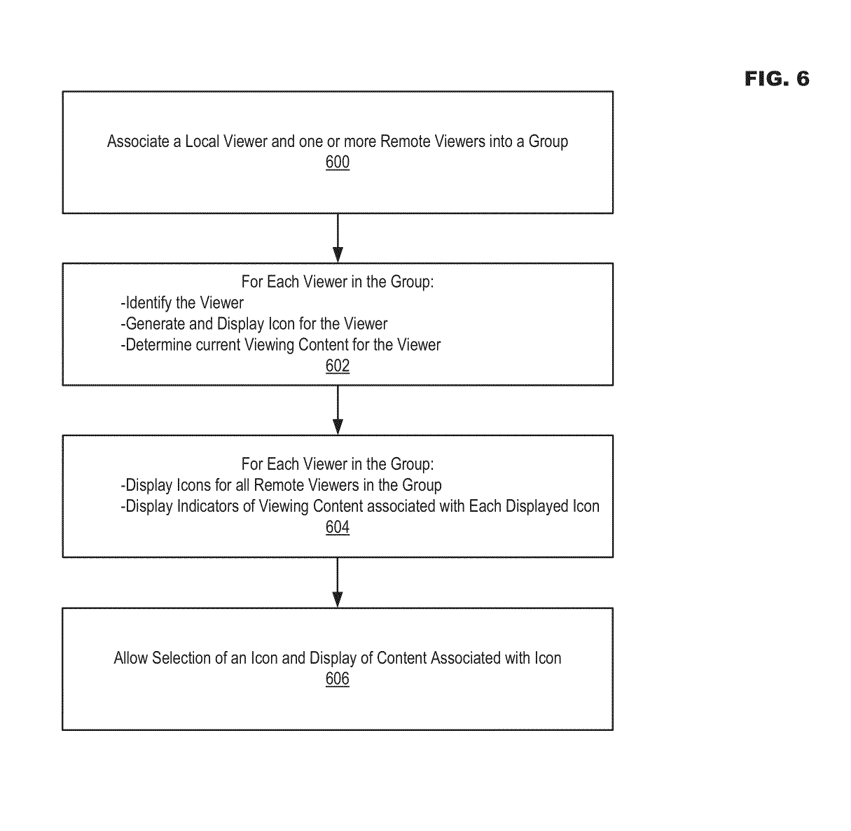

FIG. 6 illustrates a flowchart of example operations corresponding to the group-based content control embodiment shown in FIG. 5. In operation 600 a local viewer and one or more remote viewers may be associated into a group. For example, at least one of the local viewer or the remote viewers may define the members of the group in their user profile. In operation 602 each viewer in the group may be identified, an icon may be generated for the viewer and the icon may be displayed locally, for example, based on the operations described in FIG. 2A and 2B. In addition, the current content being viewed by each viewer in the group may be determined. In operation 604 icons for all of the remote viewers in the group may be displayed for each local viewer. The local and remote viewer icons may further be displayed with one or more indicators adjacent to each icon, the indicators corresponding to the content currently being viewed by each group member. For example, one of the indicators may represent the channel being watched by the user while the other indicator may represent the actual content. In operation 606 the local viewer may select an icon associated with a remote group member, and the content associated with the remote group member may be displayed on the video monitor of the local viewer.

While FIG. 2A, 2B, 4 and 6 illustrate various operations according to several embodiments, it is to be understood that not all of the operations depicted in FIG. 2A, 2B, 4 and 6 are necessary for other embodiments. Indeed, it is fully contemplated herein that in other embodiments of the present disclosure, the operations depicted in FIG. 2A, 2B, 4 and 6 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended, that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

Thus, the present disclosure provides a method and system for providing a status icon for interactive media. The system may be configured to capture an image of a Viewer, identify the Viewer and create an icon for display on a TV. The icon may be associated with indicators corresponding to the channel and/or programming being viewed by the Viewer. In addition to the system controlling the TV based on the identity of the Viewer, icons for other people of interest may also be displayed on the TV, allowing the Viewer may be aware of, and possibly follow, what other people are viewing.

According to one aspect there is provided a method. The method may include capturing an image, detecting at least one face in the image, determining an identity and expression corresponding to the at least one face, generating an icon for the at least one face based on the corresponding expression, and displaying the icon on a video monitor.

According to another aspect there is provided a system. The system may include a camera configured to capture an image, a video monitor configured to display at least content and icons, and one or more storage mediums having stored thereon, individually or in combination, instructions that when executed by one or more processors result in the following operations comprising capturing an image, detecting at least one face in the image, determining an identity and expression corresponding to the at least one thee, generating an icon for the at least one face based on the corresponding expression, and displaying the icon on the video monitor.

According to another aspect there is provided a system. The system may include one or more storage mediums having stored thereon, individually or in combination, instructions that when executed by one or more processors result in the following operations comprising capturing an image, detecting at least one face in the image, determining an identity and expression corresponding to the at least one face, generating an icon for the at least one face based on the corresponding expression, and displaying the icon on a video monitor.

The terms and expressions which have been employed herein are used as terms of description and not of limitation, and there is no intention, in the use of such terms and. expressions, of excluding any equivalents of the features shown and described (or portions thereof), and it is recognized that various modifications are possible within the scope of the claims. Accordingly, the claims are intended to cover all such equivalents.

What is claimed:

1. A system, comprising:
a camera configured to capture an image;
a video monitor configured to display at least content and icons; and
one or more storage mediums having stored thereon, individually or in combination, instructions that when executed by one or more processors result in the following operations comprising;
capturing an image;
detecting at least one face in the image;
determining an identity and expression corresponding to the at least one face;
generating an icon for the at least one face based on the corresponding expression; and
displaying the icon on the video monitor.

2. The system of claim 1, wherein the icon is a cartoon or sketch of the at least one face.

3. The system of claim 1, wherein the instructions that when executed by one or more processors result in the following additional operations:
determining content to display on the video monitor based on a selected icon, the content to display being determined based on the identity corresponding to the selected icon.

4. The system of claim 1, wherein the instructions that when executed by one or more processors result in the following additional operations:
displaying at least one icon corresponding to a remote viewer on the video monitor.

5. The system of claim 4, wherein the instructions that when executed by one or more processors result in the following additional operations:
displaying at least one indicator on the video monitor adjacent to the at least one icon corresponding to the remote viewer, the at least one indicator identifying content being viewed by the at least one remote viewer.

6. The system of claim 5, wherein the instructions that when executed by one or more processors result in the following additional operations:
determining content to display on the video monitor based on a selected icon corresponding to a remote viewer, the content to display corresponding to the at least one indicator displayed adjacent to the selected icon.

7. A system comprising one or more storage mediums having stored thereon, individually or in combination, instructions that when executed by one or more processors result in the following operations comprising:
capturing an image;
detecting at least one face in the image;
determining an identity and expression corresponding to the at least one face;
generating an icon for the at least once face based on the corresponding expression; and
displaying the icon on a video monitor.

8. The system of claim 7, wherein the icon is a cartoon or sketch of the at least one face.

9. The system of claim 7, wherein the instructions that when executed by one or more processors result in the following additional operations:
determining content to display on the video monitor based on a selected icon, the content to display being determined based on the identity corresponding to the selected icon.

10. The system of claim 7, wherein the instructions that when executed by one or more processors result in the following additional operations:
displaying at least one icon corresponding to a remote viewer on the video monitor.

11. The system of claim 10, wherein the instructions that when executed by one or more processors result in the following additional operations:
displaying at least one indicator on the video monitor adjacent to the at least one icon corresponding to the remote viewer, the at least one indicator identifying content being viewed by the at least one remote viewer.

12. The system of claim 11, wherein the instructions that when executed by one or more processors result in the following additional operations:
determining content to display on the video monitor based on a selected icon corresponding to a remote viewer, the content to display corresponding to the at least one indicator displayed adjacent to the selected icon.

13. A method, comprising:
capturing an image;
detecting at least one face in the image;
determining an identity and expression corresponding to the at least one face;
generating an icon for the at least one face based on the corresponding expression; and
displaying the icon on a video monitor.

14. The method of claim 13, wherein the icon is a cartoon or sketch of the at least one face.

15. The method of claim 13, further comprising determining content to display on the video monitor based on a selected icon, the content to display being determined based on the identity corresponding to the selected icon.

16. The method of claim 13, farther comprising displaying at least one icon corresponding to a remote viewer on the video monitor.

17. The method of claim 16, further comprising displaying at least one indicator on the video monitor adjacent to the at least one icon corresponding to the remote viewer, the at least one indicator identifying content being viewed by the at least one remote viewer.

18. The method of claim 17, farther comprising determining content to display on the video monitor based on a selected icon corresponding to a remote viewer, the content to display corresponding to the at least one indicator displayed adjacent to the selected icon.
